(19) United States
(12) Patent Application Publication
(10) Pub. No.: US 2025/0073927 A1
(43) Pub. Date: Mar. 6, 2025

(54) SYSTEMS AND METHOD FOR A SUCTION CUP APPARATUS

(71) Applicants: Hamidreza Marvi, Chandler, AZ (US); Hosain Bagheri, Phoenix, AZ (US)

(72) Inventors: Hamidreza Marvi, Chandler, AZ (US); Hosain Bagheri, Phoenix, AZ (US)

(73) Assignee: Arizona Board of Regents on Behalf of Arizona State University, Tempe, AZ (US)

(21) Appl. No.: 18/754,756

(22) Filed: Jun. 26, 2024

Related U.S. Application Data
(60) Provisional application No. 63/523,316, filed on Jun. 26, 2023.

(51) Int. Cl. B25J 15/06

(52) U.S. Cl. CPC B25J 15/0683

(57) ABSTRACT

A suction cup device is operable for precisely-controlled attachment and detachment with an object surface, and can include attachment actuators that activate to form a seal between the suction cup device and the object surface by decreasing a cavity pressure of the suction cup device. Following attachment, the attachment actuators can deactivate to hold the seal in a “passive” mode. For detachment from the object surface, the suction cup device can include detachment actuators that increase the cavity pressure to break the seal and release the object surface from the suction cup device.

### CROSS REFERENCE TO RELATED APPLICATIONS

This is a non-provisional application that claims benefit to U.S. Provisional Application Ser. No. 63/523,316, filed on Jun. 26, 2023, which is herein incorporated by reference in its entirety.

### GOVERNMENT SUPPORT

This invention was made with government support under N00014-17-1-2117 awarded by the Office of Naval Research. The government has certain rights in the invention.

### FIELD

The present disclosure generally relates to an attachment apparatus, and in particular to systems and methods for a novel suction cup apparatus for attaching and detaching with various objects or surfaces.

### BACKGROUND

The ability to bend, deform, configure, and adapt to surroundings makes soft robotics especially useful for the navigation of unpredictable, unstructured, and confined environments. However, development of highly versatile soft robots has been held back by the challenge of controlling high-dimensional appendages. While many advances in the field of soft robotics have been made, these advances have failed to produce an effective means for controlling soft appendages that can assist in tasks such as manipulation of objects or detachably anchoring the soft robot to a surface. This issue is notably prevalent when attempting to create soft robotic components that operate with sufficient precision and control to manipulate delicate objects.

Biology serves as a rich source of design inspiration for soft robotics and presents diverse mechanisms for controlling soft high-dimensional appendages and bodies. The octopus, in particular, demonstrates a high degree of control, adaptability, and limitless degrees of freedom with its arms, making it an ideal source of inspiration for soft robot design. The suction cups lining each of the octopus arms are capable of creating a strong yet delicate grip on various topologies and surfaces through the use of friction and negative pressure within each suction cup. Despite biologist's understanding of octopus suckers, difficulty still presents itself in mimicking these mechanisms due to the complexity of the organism and its biological systems.

Existing soft robotic components intended to mimic the octopus suction cup rely on pneumatic mechanisms. However, these components fail to provide a solution that can maintain a grip on an object held by the pneumatic component in the case of a power outage. Because industries that engage in the processing and manufacturing of delicate objects are at an especially high risk of damaging the delicate objects during a power outage, a soft robot component that is capable of maintaining a delicate and firm grip with or without power is needed.

Effective detachment mechanisms are also an area of notable difficulty in mimicking the octopus suction cup. With a stronger means of attachment used by the soft robot component comes an increased risk of damaging the component itself as well as the object being held during detachment. Thus, creation of a reusable, durable, and strong attachment/detachment mechanism thus remains an open problem within soft robotics as well as other industrial applications that require attachment/detachment of various types of objects.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is a simplified illustration showing a suction cup device that is operable for self-actuated attachment and detachment with an object or surface;

FIGS. 1B and 1C are a pair of simplified illustrations showing an actuator of the suction cup device of FIG. 1A in a relaxed state and a contracted state;

FIGS. 2A-2C are a series of illustrations showing a first embodiment of the suction cup device of FIGS. 1A-1C, where FIG. 2A is a cross-sectional side view of the suction cup device, FIG. 2B is a cross-sectional top view of the suction cup device of FIG. 2A taken along line 2B-2B showing radial actuators, and FIG. 2C is a cross-sectional top view of the suction cup device of FIG. 2A taken along line 2C-2C showing circular actuators;

FIGS. 3A and 3B are a pair of illustrations showing operation of the radial actuators of FIGS. 2A and 2B for attachment of the suction cup device to an object or surface;

FIGS. 4A and 4B are a pair of illustrations showing operation of the circular actuators of FIGS. 2A and 2C for detachment of the suction cup device from an object or surface;

FIG. 5 is an illustration showing a second embodiment of the suction cup device that features axial actuators, circular actuators, inner flange actuators, and outer flange actuators;

FIGS. 6A-6C are a series of illustrations showing the second embodiment of the suction cup device of FIG. 5, where FIG. 6A is a cross-sectional side view of the suction cup device, FIG. 6B is a cross-sectional top view of the suction cup device of FIG. 6A taken along line 6B-6B showing axial and circular actuators, and FIG. 6C is a cross-sectional top view of the suction cup device of FIG. 6A taken along line 6C-6C showing inner flange actuators and outer flange actuators;

FIGS. 7A and 7B are a pair of illustrations showing operation of the axial and inner flange actuators of FIGS. 6A-6C for attachment of the suction cup device to an object or surface;

FIGS. 8A and 8B are a pair of illustrations showing operation of the circular and outer flange actuators of FIGS. 6A-6C for detachment of the suction cup device from an object or surface;

FIG. 9 is an illustration showing a sucker of an octopus that was studied for development of the suction cup devices of FIGS. 1A-8B;

FIGS. 10A-10D are a series of illustrations showing an attachment process of the sucker of FIG. 9;

FIG. 11 is a simplified illustration showing a system incorporating the suction cup devices of FIGS. 1A-8B positioned along a robotic arm for handling brittle media objects;

FIG. 12 is a simplified illustration showing out-of-plane warping correction by the system of FIG. 11;

FIGS. 13A-13C are a series of process flow diagrams showing a method for attachment and detachment by the suction cup devices of FIGS. 1A-8B; and

FIG. 14 is a simplified block diagram showing an example computing device that can be used to control the suction cup devices of FIGS. 1A-8B.

Corresponding reference characters indicate corresponding elements among the view of the drawings. The headings used in the figures do not limit the scope of the claims.

### DETAILED DESCRIPTION

Systems and methods are outlined herein for a suction cup device that is operable for precisely-controlled attachment and detachment with an object or surface. The suction cup device can include attachment actuators that activate to form a seal between the suction cup device and an object surface by decreasing a cavity pressure within a cavity of the suction cup device, and can deactivate to hold the seal in a “passive” mode. For detachment, the suction cup device can include detachment actuators that increase the cavity pressure to break the seal and release the object surface from the suction cup device. In some examples, the suction cup device can be used as part of a soft robotics system as part of a manufacturing or otherwise handling process for brittle media objects such as electronic wafers.

### Suction Cup Device Overview

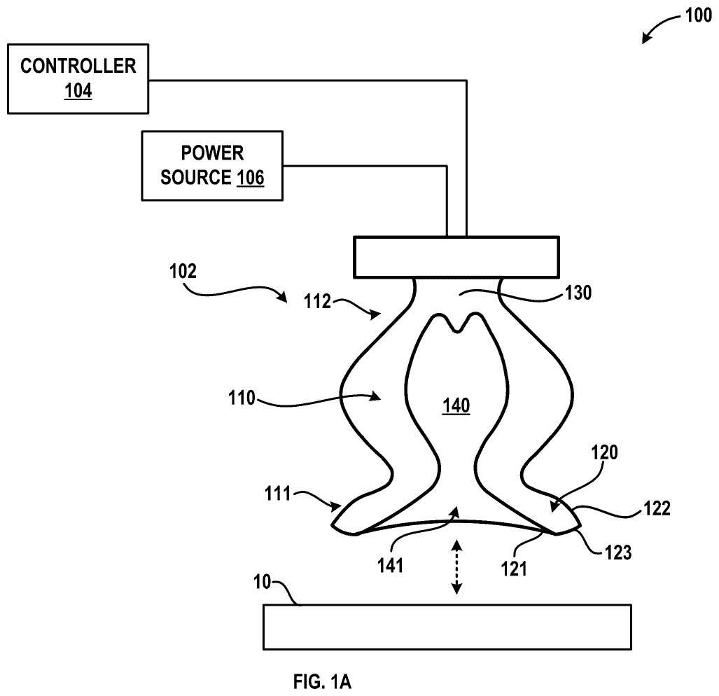

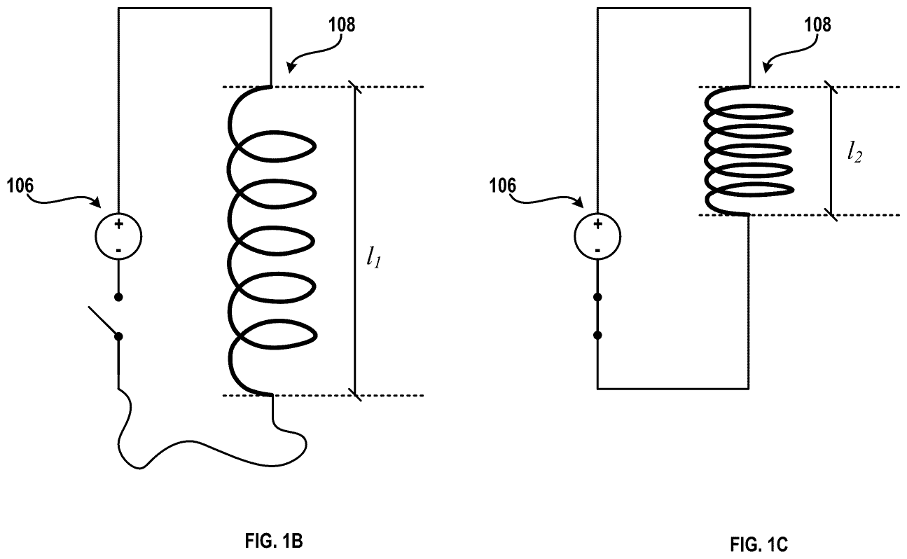

FIG. 1A shows a general structure of a suction cup device 100 having a body 102 including a sidewall 110, where a cross-sectional side view of the body 102 is shown. The sidewall 110 can include a distal portion 111 defining a flange 120 that extends from the distal portion 111 of the sidewall 110. The flange 120 can engage an object surface 10 as outlined in further detail herein. Further, the sidewall 110 can include a proximal portion 112 defining a base 130 which extends from the proximal portion 112 of the sidewall 110 opposite from the flange 120.

The base 130, the sidewall 110 and the flange 120 collectively define a cavity 140 having an open portion 141 associated with the flange 120. Importantly, the flange 120 is operable for forming a seal against the object surface 10 that isolates the cavity 140 from an external environment. As shown in FIG. 1A, the flange 120 includes an inner flange surface 121 associated with the cavity 140, an outer flange surface 122 associated with the external environment, and a rim 123 therebetween. The body 102 can include a pliable material that is impermeable to gas and liquid, and may be composed of any suitable soft material that can be cast, molded, or 3D-printed, such as silicone rubber, polydimethylsiloxane (PDMS), or polyurethane. In some applications, such as wafer handling in semiconductor manufacturing, it may be important for the suction cup device 100 to be composed of a material that does not leave a particle residue. In many applications it may be important for the suction cup device 100 to be formed from a material having elastic properties such that the body 102 may retain its original shape after shape manipulation occurs.

The base 130 can electrically couple attachment actuators and detachment actuators of the suction cup device 100 with electronic elements such as (but not limited to) a controller device 104 and a power source 106. In some examples, the controller device 104 can communicate with the power source 106 through wired or wireless connection. As outlined further herein, the attachment actuators activate responsive to first control signals from the controller device 104 to attach the flange 120 to the object surface 10 by decreasing a cavity pressure associated with the cavity 140. The first control signals from the controller device 104 can cause the power source 106 to apply a voltage to the attachment actuators, thereby activating the attachment actuators. Likewise, as outlined further herein, the one or more detachment actuators activate responsive to second control signals from the controller device 104 to detach the flange 120 from the object surface 10. The second control signals from the controller device 104 can cause the power source 106 to apply a voltage to the detachment actuators, thereby activating the detachment actuators. Additionally, the suction cup device 100 can include one or more sensors, which can communicate with the controller device 104 and can provide information about a topology of the object surface 10 and/or a cavity pressure of the cavity 140, which can in turn affect control and actuation of the attachment actuators and/or detachment actuators.

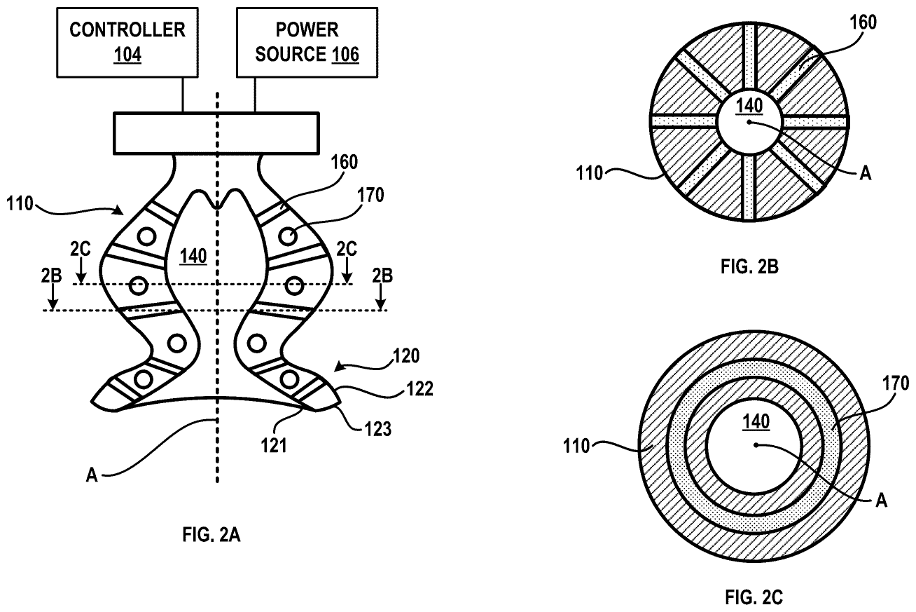

FIGS. 1B and 1C are a pair of illustrations showing contraction of an actuator 108, which can apply to the attachment actuators and the detachment actuators outlined in further detail herein (e.g., as radial actuators 160, circular actuators 170, axial actuators 260, inner flange actuators 262, and/or outer flange actuators 272 shown in FIGS. 2A-8B). The actuator 108 can be constructed from an electro-active material (e.g., a polymer or shape-memory alloy (SMA), etc.) that actuates/moves/shrinks upon applying a voltage. For example, the actuator 108 may be in the form of a simple spring that is electrically coupled to the power source 106 which can be controlled by controller device 104. Importantly, the actuator 108 can assume a relaxed state as in FIG. 1B when no current is passed through the actuator 108, and can transition to a contracted state as in FIG. 1C when voltage (as first control signal or second control signal generated from power source 106) is applied to the actuator 108. In FIG. 1B, the actuator 108 in its relaxed state has a first length l₁, and upon application of the voltage as in FIG. 1C, the actuator 108 contracts to a second (reduced) length l₂ where the second length l₂<l₁.

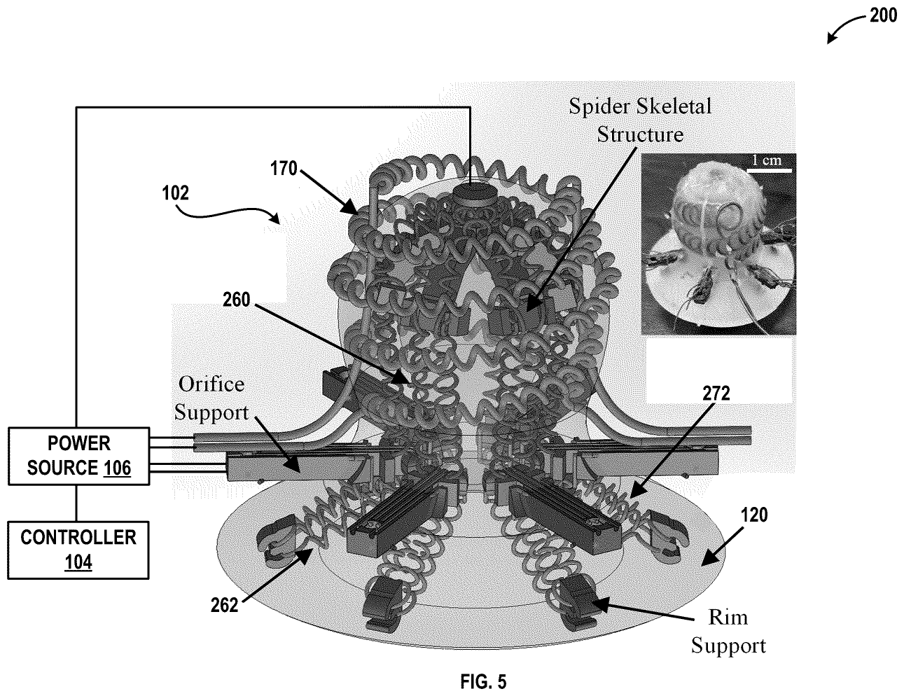

In the embodiments outlined herein, FIGS. 2A-4B show arrangement and operation of a first embodiment of the suction cup device, e.g., where the plurality of attachment actuators include radial actuators 160 and the plurality of detachment actuators include circular actuators 170. FIGS. 5-8B show arrangement and operation of a second embodiment of the suction cup device, e.g., where the plurality of attachment actuators include axial actuators 260 that operate in conjunction with inner flange actuators 262, and the plurality of detachment actuators include circular actuators 170 that operate in conjunction with outer flange actuators 272.

### First Embodiment Actuators

FIGS. 2A-2C show cross-sectional images of a first embodiment of the suction cup device 100 including a plurality of attachment actuators and a plurality of detachment actuators which can be electrically coupled to the controller device 104 and the power source 106.

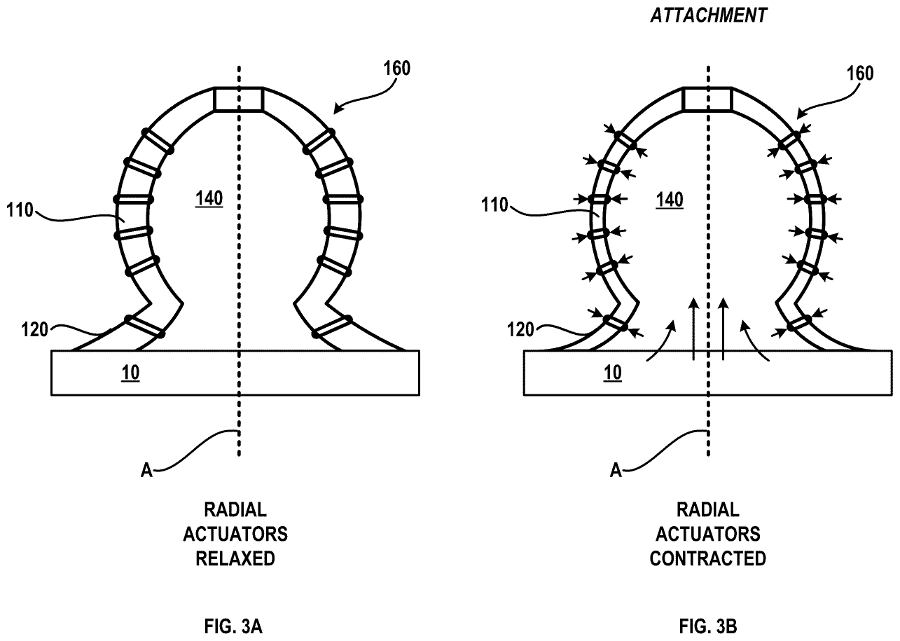

In the embodiment of FIGS. 2A and 2B (where FIG. 2B is a cross-sectional top view taken along line 2B-2B in FIG. 2A), the plurality of attachment actuators can include radial actuators 160 embedded within the sidewall 110 that contract responsive to the first control signals, thereby increasing a tension associated with the sidewall 110 and decreasing the cavity pressure associated with the cavity 140. The radial actuators 160 define a radial direction of contraction with respect to a central cavity axis A associated with the cavity 140 and can be oriented radially around the cavity 140 with respect to the central cavity axis A as shown in FIG. 2B. The radial actuators 160 operate to create a suction force that seals the flange 120 against the object surface 10. Following attachment, the radial actuators 160 can deactivate while the suction cup device 100 remains attached to the object surface 10, e.g., in a “passive attachment” mode. Operation of the radial actuators 160 is further outlined herein with respect to FIGS. 3A and 3B.

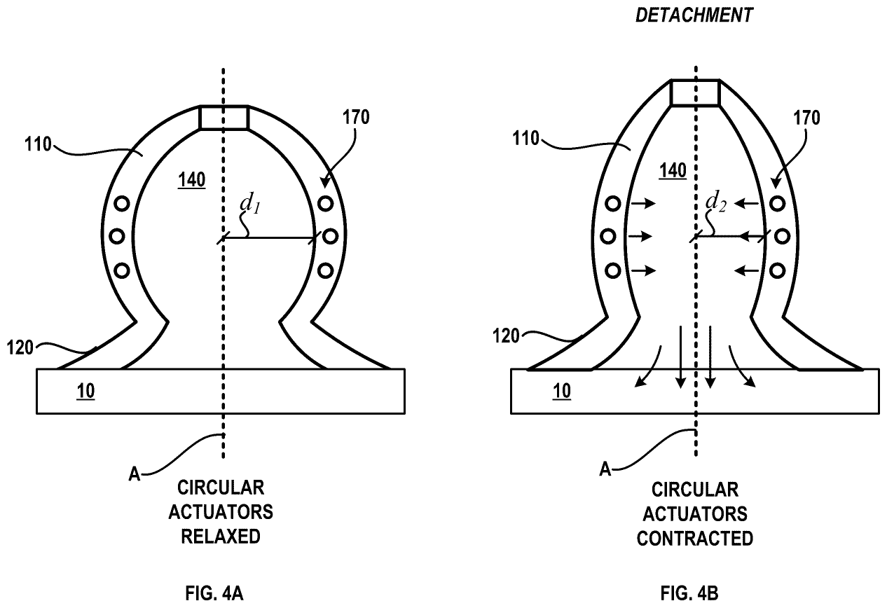

Further, in the embodiment of FIGS. 2A and 2C, (where FIG. 2C is a cross-sectional top view taken along line 2C-2C in FIG. 2A), the plurality of detachment actuators can include one or more circular actuators 170 embedded within the sidewall 110 that contract responsive to the second control signals thereby decreasing a diameter associated with the cavity 140 and increasing the cavity pressure associated with the cavity 140. The circular actuator 170 define an annular direction of contraction with respect to the central cavity axis A associated with the cavity 140, and can wrap annularly around the cavity 140 of the body 102 to “squeeze” the cavity 140 and increase the cavity pressure to break the seal between the flange 120 and the object surface 10. Operation of the circular actuators 170 is further outlined herein with respect to FIGS. 4A and 4B.

The radial actuators 160 and the circular actuators 170 can contract upon application of voltage as discussed herein with respect to the example actuator 108 shown in FIGS. 1B and 1C.

The detachment actuators (i.e., circular actuators 170) are inactive during activation of the attachment actuators (i.e., radial actuators 160). Likewise, the attachment actuators (i.e., radial actuators 160) are inactive during activation of the detachment actuators (i.e., circular actuators 170).

### Attachment Actuators (Radial Actuators)

FIGS. 3A and 3B show operation of the radial actuators 160 for attachment of the flange 120 against the object surface 10. In FIG. 3A, the radial actuators 160 embedded within the sidewall 110 are relaxed, and the object surface 10 may be positioned against the flange 120 to isolate the cavity 140 from the external environment without a significant difference between the cavity pressure of the cavity 140 and the external environment. As shown in FIG. 3B, the radial actuators 160 contract responsive to the first control signals to increase a tension associated with the sidewall 110, thereby decreasing a pressure (creating a suction force) within the cavity 140 and creating a seal between the flange 120 and the object surface 10 to attach the object surface 10 to the suction cup device 100. Importantly, the radial actuators 160 define a radial direction of contraction with respect to the central cavity axis A associated with the cavity 140. Following establishment of the seal and attachment of the object surface 10 to the suction cup device 100, the radial actuators 160 can deactivate and enter a “passive attachment” mode where the object surface 10 remains attached to the suction cup device 100 without active actuation of the radial actuators 160.

### Detachment Actuators (Circular Actuators)

FIGS. 4A and 4B show operation of the circular actuators 170 for detachment of the flange 120 from the object surface 10. In FIG. 4A, the circular actuators 170 embedded within the sidewall 110 are relaxed, and the object surface 10 may be attached to the suction cup device 100 without active actuation of the radial actuators 160 (FIGS. 3A and 3B). In FIG. 4A, the cavity 140 is shown having a first diameter d₁. As shown in FIG. 4B, the circular actuators 170 contract responsive to the second control signals to “squeeze” the cavity 140 and decrease the diameter of the cavity 140 to a second diameter d₂ (from d₁ to d₂, where d₂<d₁) associated with the cavity 140. This action thereby increases the pressure within the cavity 140 and breaks the seal between the flange 120 and the object surface 10 to detach the object surface 10 from the suction cup device 100. Importantly, the circular actuator 170 defines an annular direction of contraction with respect to the central cavity axis A associated with the cavity 140.

### Second Embodiment Actuators

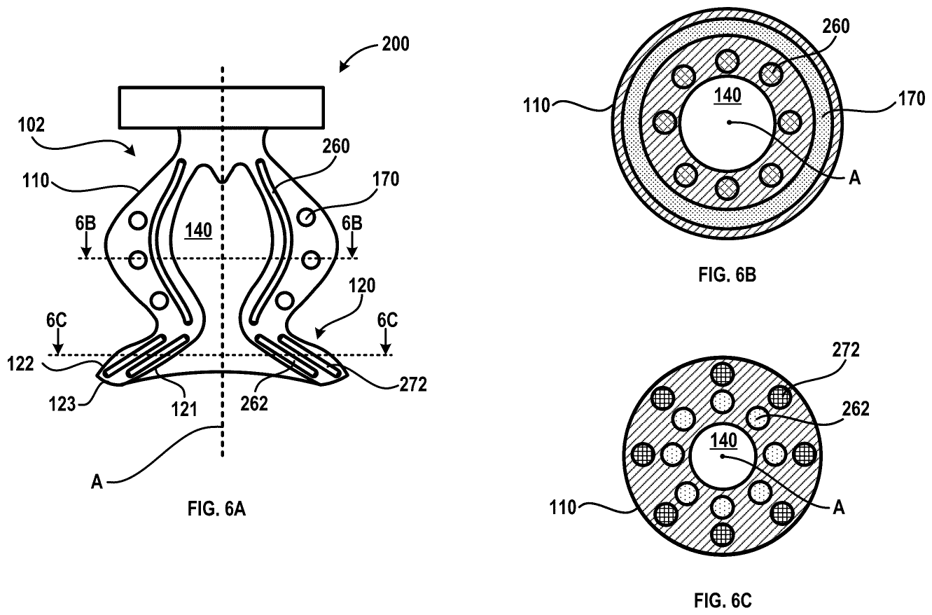

FIGS. 5 and 6A-6C show a second embodiment of a suction cup device 200 which can include the body 102 of FIG. 1A, with alternate arrangements of the attachment actuators and detachment actuators which can be electrically coupled to the controller device 104 and the power source 106. As mentioned herein, the plurality of attachment actuators can include axial actuators 260 that operate in conjunction with inner flange actuators 262, and the plurality of detachment actuators include circular actuators 170 (similar to the circular actuators of FIGS. 2A, 2C, 4A and 4B) that operate in conjunction with outer flange actuators 272. The axial actuators 260, the inner flange actuators 262, the circular actuators 170, and the outer flange actuators 272 can contract upon application of voltage as discussed herein with respect to the example actuator 108 shown in FIGS. 1B and 1C.

FIG. 5 also illustrates various supporting structures (orifice support, rim support, and “spider skeletal” structures) that can provide general support for the actuators embedded within the body 102 to ensure that the actuators remain in place.

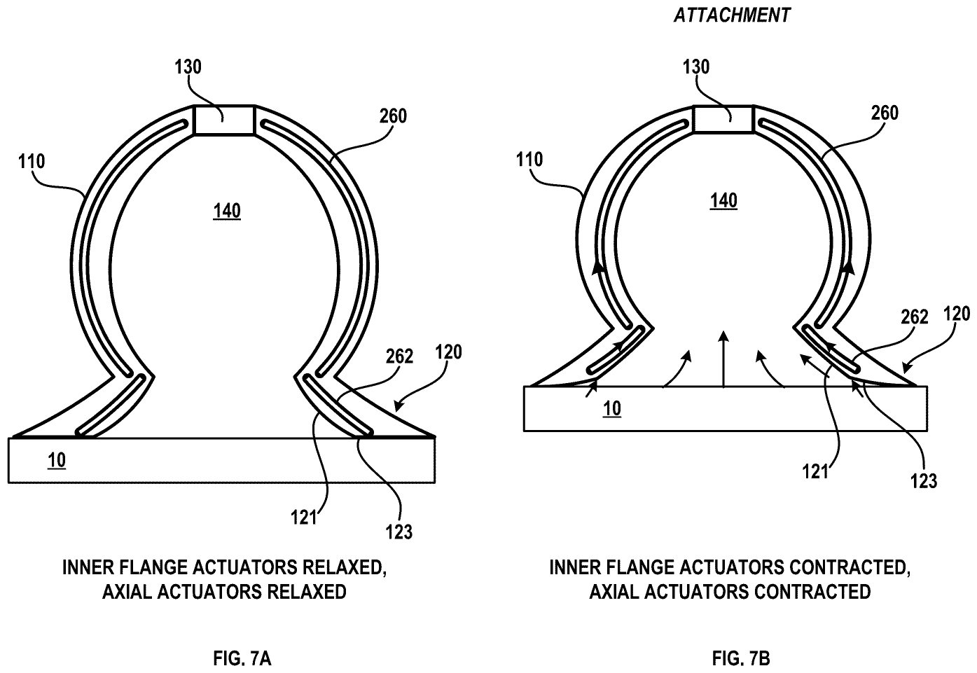

The axial actuators 260 can be embedded within the sidewall 110 and can contract responsive to the first control signals, thereby decreasing a height of the cavity 140 and drawing the flange 120 and object surface 10 upward, as well as increasing a tension associated with the sidewall 110. In contrast to the radial actuators 160 of FIGS. 2A, 2B, 3A and 3B, the axial actuators 260 define an axial direction of contraction that is substantially parallel to a direction of elongation of the sidewall 110 as shown in FIGS. 6A and 6B. The inner flange actuators 262 can be embedded within the flange 120, particularly associated with the inner flange surface 121 of the flange 120, which can also contract responsive to the first control signals to form a seal between the rim 123 of the flange 120 and the object surface 10 when the flange 120 is in contact with the object surface 10. The inner flange actuators 262 define an axial direction of contraction with respect to the inner flange surface 121, as shown in FIG. 6C. Following attachment, the axial actuators 260 and inner flange actuators 262 can deactivate while the suction cup device 200 remains attached to the object surface 10, e.g., in a “passive attachment” mode. Operation of the axial actuators 260 and inner flange actuators 262 are further outlined herein with respect to FIGS. 7A and 7B.

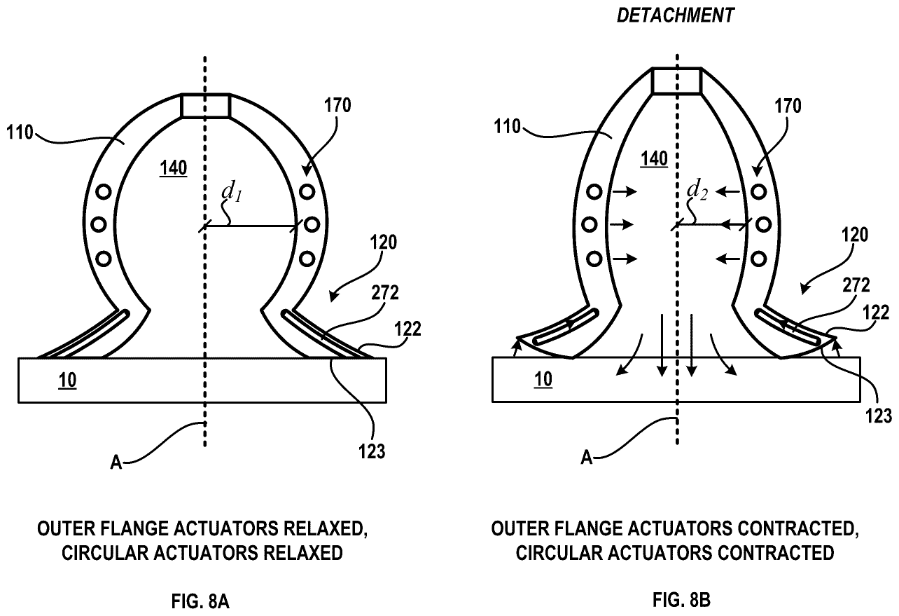

Similar to the embodiment of FIGS. 2A, 2C, 4A and 4B, the circular actuators 170 can be embedded within the sidewall 110 and can contract responsive to the second control signals thereby decreasing a diameter associated with the cavity 140 and increasing the cavity pressure associated with the cavity 140. As discussed, the circular actuator 170 define an annular direction of contraction with respect to the central cavity axis A associated with the cavity 140 as shown in FIGS. 6A and 6B, and can wrap annularly around the cavity 140 of the body 102 to “squeeze” the cavity 140 and increase the cavity pressure to break the seal between the flange 120 and the object surface 10. In addition, the outer flange actuators 272 can be embedded within the flange 120, particularly associated with the outer flange surface 122 of the flange 120, and can contract responsive to the second control signals and to break the seal between the rim 123 of the flange 120 and the object surface 10. The outer flange actuator 272 can define an axial direction of contraction with respect to the outer flange surface 122, as shown in FIG. 6C. Operation of the circular actuators 170 and outer flange actuators 272 are further outlined herein with respect to FIGS. 8A and 8B.

The detachment actuators (i.e., circular actuators 170 and outer flange actuators 272) are inactive during activation of the attachment actuators (i.e., axial actuators 260 and inner flange actuators 262). Likewise, the attachment actuators (i.e., axial actuators 260 and inner flange actuators 262) are inactive during activation of the detachment actuators (i.e., circular actuators 170 and outer flange actuators 272).

### Attachment Actuators (Axial and Inner Flange Actuators)

FIGS. 7A and 7B show operation of the axial actuators 260 and inner flange actuators 262 for attachment of the flange 120 against the object surface 10. In FIG. 7A, the axial actuators 260 and inner flange actuators 262 embedded within the sidewall 110 and inner flange surface 121 are relaxed, and the object surface 10 may be positioned against the flange 120 to isolate the cavity 140 from the external environment without a significant difference between the cavity pressure of the cavity 140 and the external environment.

As shown in FIG. 7B, the axial actuators 260 contract responsive to the first control signals thereby decreasing a height of the cavity 140 and drawing the flange 120 and object surface 10 upward, as well as increasing a tension associated with the sidewall 110, resulting in a decrease in cavity pressure (creating a suction force) associated with the cavity 140. Further, the inner flange actuator 262 contracts responsive to the first control signals and draws the inner flange surface 121 upward and/or inward towards the base 130 of the body 102 as shown in FIG. 7B to form a seal between the rim 123 of the flange 120 and the object surface 10 when the flange 120 is in contact with the object surface 10.

The axial actuators 260 define an axial direction of contraction that is substantially parallel to a direction of elongation of the sidewall 110, and the inner flange actuators 262 define an axial direction of contraction with respect to the inner flange surface 121 that can be substantially parallel to a direction of elongation of the inner flange surface 121. Following establishment of the seal and attachment of the object surface 10 to the suction cup device 100, the axial actuators 260 and inner flange actuators 262 can deactivate and enter a “passive attachment” mode where the object surface 10 remains attached to the suction cup device 200 without active actuation of the axial actuators 260 or inner flange actuators 262.

### Detachment Actuators (Circular and Outer Flange Actuators)

FIGS. 8A and 8B show operation of the circular actuators 170 and outer flange actuators 272 for detachment of the flange 120 from the object surface 10. In FIG. 8A, the circular actuators 170 and outer flange actuators 272 are relaxed, and the object surface 10 may be attached to the suction cup device 200 without active actuation of the axial actuators 260 or inner flange actuators 262 (FIGS. 7A and 7B).

As shown in FIG. 8B, the circular actuators 170 and outer flange actuators 272 contract responsive to the second control signals to detach the flange 120 from the object surface 10. In particular, similar to the example in FIGS. 4A and 4B, contraction of the circular actuators 170 decreases a diameter (from d₁ to d₂ where d₂<d₁) associated with the cavity 140 and increases the cavity pressure associated with the cavity 140. Further, the outer flange actuator 272 contracts responsive to the second control signals and raises the rim 123 of the flange 120 away from the object surface 10 to break a seal between the rim 123 of the flange 120 and the object surface 10.

The circular actuators 170 define an annular direction of contraction with respect to the central cavity axis A associated with the cavity 140, and the outer flange actuators 272 define an axial direction of contraction with respect to the outer flange surface 122 that can be substantially parallel to a direction of elongation of the outer flange surface 122.

### Outer and Inner Flange Actuators

Note there is an important distinction between raising a portion of the rim 123 associated with the outer flange surface 122 by the outer flange actuator 272 (as in the detachment mechanism of FIG. 8B) and raising a portion of the rim 123 associated with the inner flange surface 121 by the inner flange actuator 262 (as in the attachment mechanism FIG. 7B).

In FIG. 7B showing attachment, the inner flange actuator 262 raises the inner flange surface 121 while the portion of the rim 123 associated with the outer flange surface 122 remains in contact with the object surface 10 to create and maintain the seal, isolating the cavity 140 from the external environment and creating a suction force such that the object surface 10 adheres to the rim 123 of the flange 120. This action, in conjunction with the increased tension in the sidewall 110 introduced by the axial actuators 260 that decreases the pressure within the cavity 140, securely attaches the rim 123 of the flange 120 to the object surface 10.

In FIG. 8B showing detachment, the outer flange actuator 272 raises the outer flange surface 122 while the portion of the rim 123 associated with the inner flange surface 121 may temporarily remain in contact with the object surface 10. Raising the outer flange surface 122 allows media (e.g., a gas or liquid) from the external environment to enter the (lower-pressure) cavity 140 from the external environment and break the seal, eventually causing the entire rim 123 to detach from the object surface. This action, in conjunction with the increase in cavity pressure introduced by the circular actuators 170, detaches the rim 123 of the flange 120 from the object surface 10.

### Octopus Study

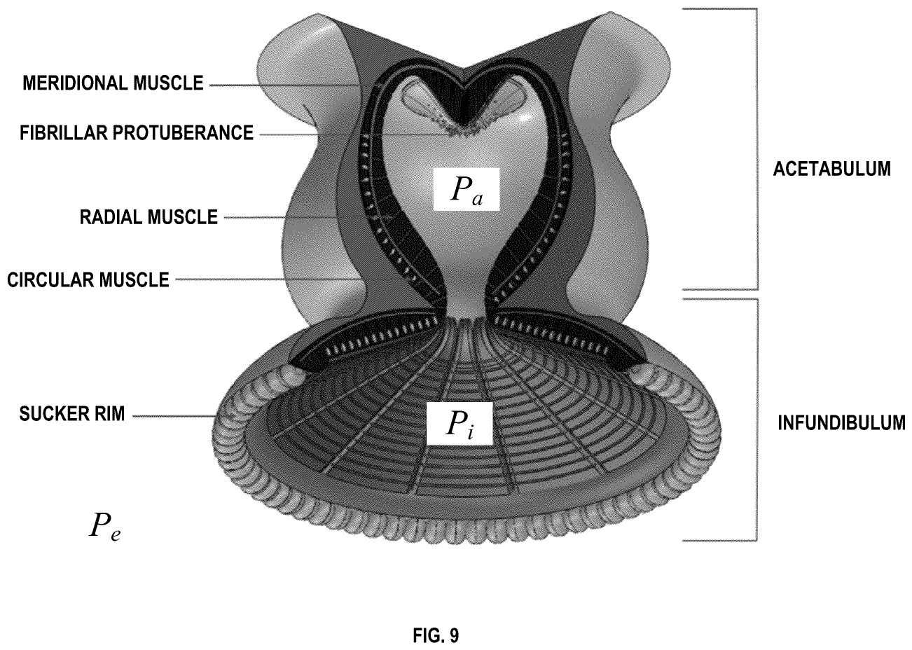

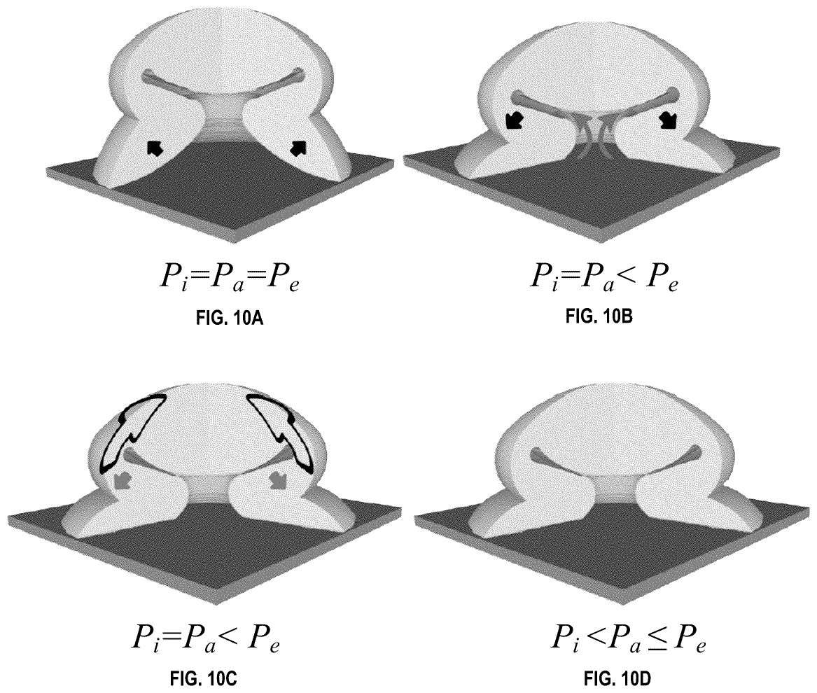

FIGS. 9-10D show information about operation of an octopus “sucker” which was studied for development of the suction cup device 100 and suction cup device 200. FIG. 9 presents an annotated cross-sectional illustration of an octopus sucker found in nature. The octopus sucker includes an acetabulum having an acetabulum cavity (with pressure Pₐ) and defining a fibrillar protuberance within the acetabulum cavity, and an infundibulum opposite from the fibrillar protuberance which communicates with the acetabulum cavity. An infundibulum cavity is denoted as having pressure Pᵢ. An external environment is illustrated as having a pressure Pₑ. The octopus sucker includes radial muscles, circular muscles, and meridional muscles which collectively work to initiate attachment and detachment of the infundibulum to and from a surface. FIGS. 10A-10D show a four-phase attachment process for the octopus sucker of FIG. 9.

As shown in FIG. 10A, the attachment process begins with the infundibulum pressing and conforming to a surface, and the rim sealing the cavity and preventing water leakage (isolating the cavity from the external environment). At this point, there may be no significant pressure difference between the acetabulum cavity, the infundibulum cavity, and the external environment (e.g., Pₐ=Pᵢ=Pₑ). As shown in FIG. 10B, the acetabulum begins contracting radially, decreasing the inner pressures relative to the external environment (e.g., Pₐ=Pᵢ<Pₑ). As shown in FIG. 10C, the meridional muscles then contract and deform the sucker until the fibrillar protuberance adheres to the sidewalls (through friction), forming a toroidal water cavity. As shown in FIG. 10D, the radial and meridional muscles relax while the sucker configuration remains passively fixed and attached to the surface due to friction between the fibrillar protuberance and sidewalls, as well as the pressure differential created by the toroidal water cavity (e.g., Pₐ<Pᵢ≤Pₑ). During detachment, the circular muscles contract to rupture the seal between the sucker rim and the surface as well as the contact between the fibrillar protuberance and the sidewalls.

### Practical Application Example: Soft Robotics System

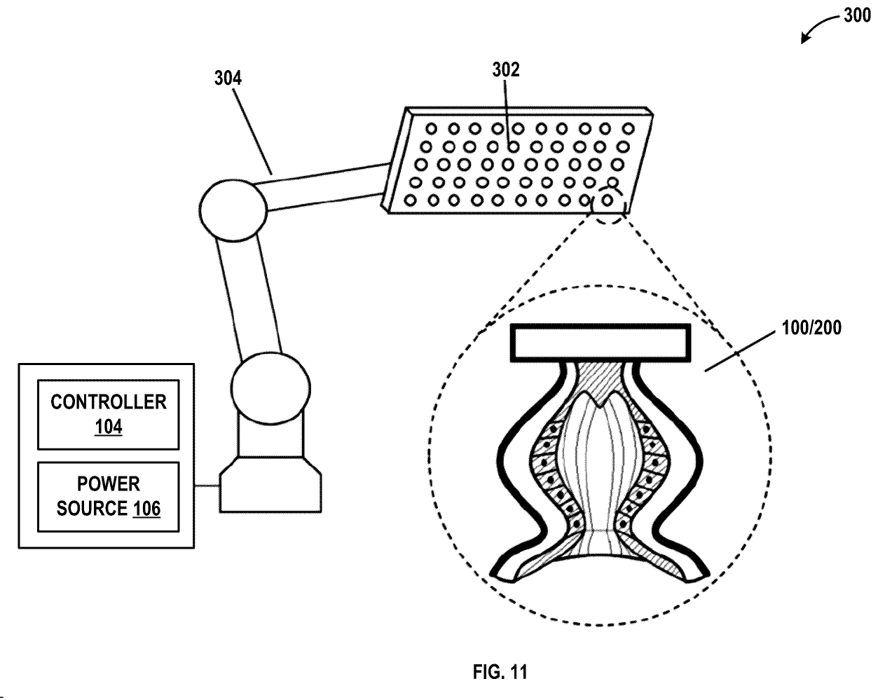

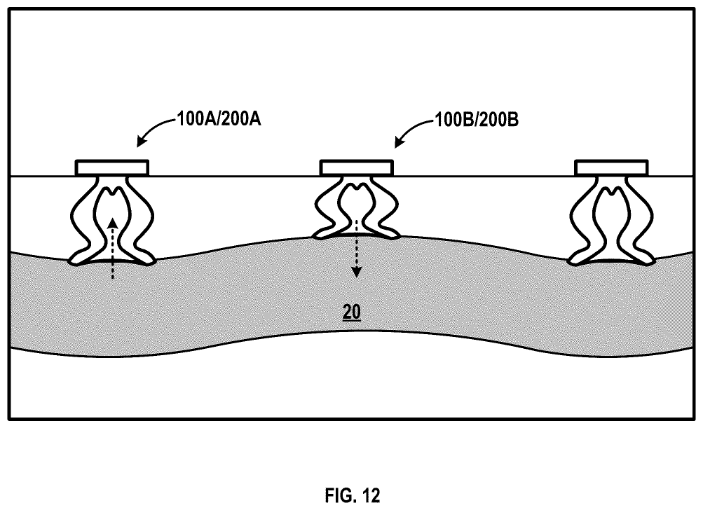

FIGS. 11 and 12 show example practical applications of the suction cup device 100 or suction cup device 200 which can be used as part of a soft robotics system 300, such as a system for handling brittle media objects (e.g., semiconductor wafers, etc.). In the example of FIG. 11, the suction cup device 100 or suction cup device 200 is one of a plurality of suction cup devices positioned in array along an effective end 302 of a robotic arm 304 that can be used to pick up an object by activating the attachment actuators and put down the object by activating the detachment actuators. The array may operate such that each suction cup device 100 or suction cup device 200 operates separately/individually from other suction cup devices, or in unison with other suction cup devices. It is not intended to limit the operation of the array to only the recited embodiments, any quantity of the individual suction cup apparatuses may be configured to operate in unison, in discrete independent groupings, or each independent of one another.

FIG. 12 shows an example where the suction cup device 100 or suction cup device 200 can be used to correct out-of-plane warpage of a brittle media object 20. In the example, a first suction cup device 100A/200A contacts a concave portion of the brittle media object 20 and a second suction cup device 100B/200B contacts a convex portion of the brittle media object 20. To correct out-of-plane-warpage for the concave portion, attachment actuators of the first suction cup device 100A/200A can actuate to generate a suction force to pull the concave portion upward. Concurrently, for the convex portion, detachment actuators of the second suction cup device 100B/200B can actuate to push the convex portion downward.

While the array in FIGS. 11 and 12 are depicted positioned along a uniform plane, it is not limited to a particular embodiment, and therefore the array may be configured to any suitable shape, arrangement, or configuration such that array may tailored for attachment to any type of object being manipulated. As such, the soft robotics system 300 is not limited for attachment to substantially planar surfaces and may be configured to attach to any kind of surface topology, such as by nonlimiting example, curved, rough, grained, or textured topologies.

Further, the soft robotics system 300 can incorporate sensor data from one or more sensors of the suction cup device 100 or suction cup device 200 to identify and adapt to a topology of an object surface and/or to control the suction cup device 100 or suction cup device 200 based on pressures associated with the cavity 140 and the external environment.

### Method

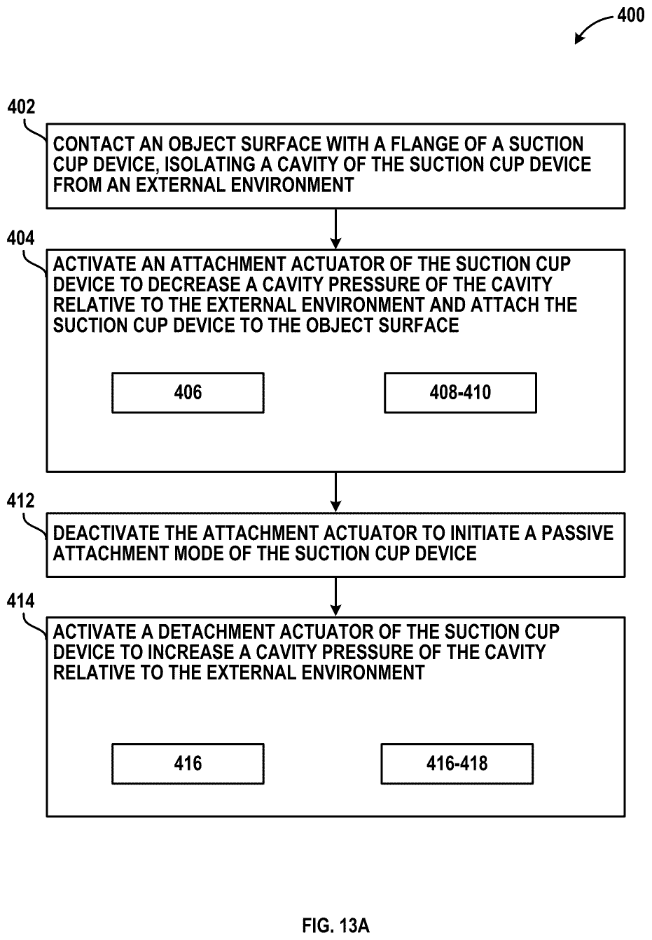

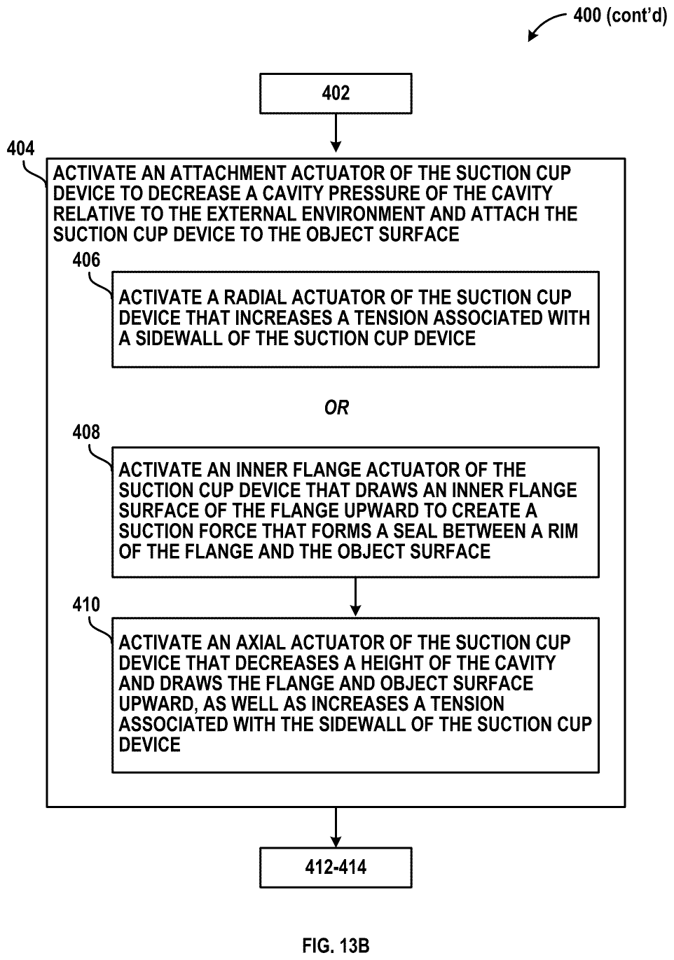

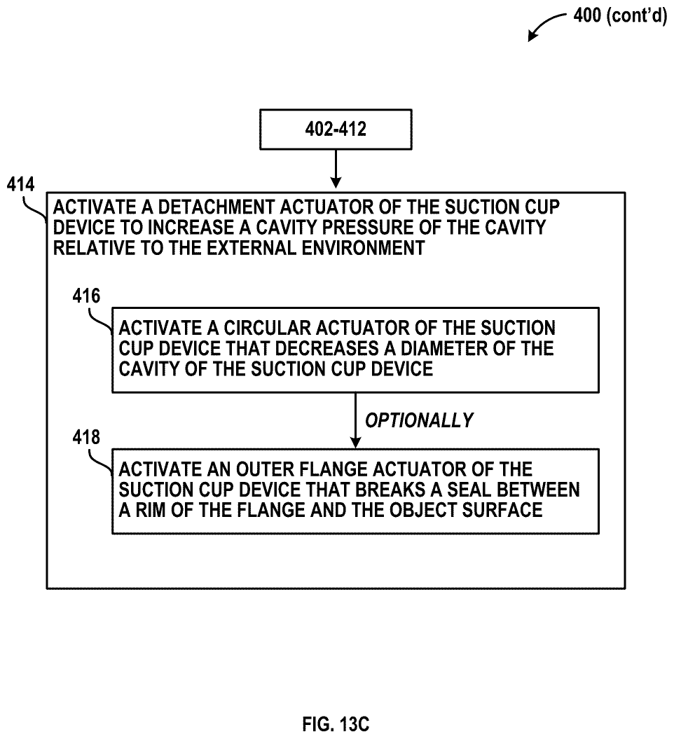

FIGS. 13A-13C show an example method 400 for attaching and detaching an object surface from the suction cup device 100 or suction cup device 200.

Step 402 of method 400 includes contacting an object surface with a flange of a suction cup device, isolating a cavity of the suction cup device from an external environment.

Step 404 of method 400 includes activating an attachment actuator of the suction cup device to decrease a cavity pressure of the cavity relative to the external environment and attach the suction cup device to the object surface, which can be accomplished by a first control signal that applies the voltage to the attachment actuator, causing the attachment actuator to transition from the relaxed state to the contracted state having the reduced length. Step 404 can be divided into multiple sub-steps, depending on the embodiment of the suction cup device. For the suction cup device 100 of FIGS. 2A-4B, step 406 of method 400 includes activating a radial actuator of the suction cup device that increases a tension associated with a sidewall of the suction cup device. For the suction cup device 200 of FIGS. 5-8B, steps 408 and 410 of method 400 respectively include: activating an inner flange actuator of the suction cup device that draws an inner flange surface of the flange upward to create a suction force that forms a seal between a rim of the flange and the object surface; and activating an axial actuator of the suction cup device that decreases a height of the cavity and draws the flange and object surface upward, as well as increases a tension associated with the sidewall of the suction cup device.

Step 412 of method 400 includes deactivating the attachment actuator to initiate a passive attachment mode of the suction cup device.

Step 414 of method 400 includes activating a detachment actuator of the suction cup device to increase a cavity pressure of the cavity relative to the external environment and detach the suction cup device from the object surface, which can be accomplished by a second control signal that applies the voltage to the detachment actuator, causing the detachment actuator to transition from the relaxed state to the contracted state having the reduced length. Step 414 can be divided into multiple sub-steps, depending on the embodiment of the suction cup device. For the suction cup device 100 of FIGS. 2A-4B, as well as for the suction cup device 200 of FIGS. 5-8B, step 414 of method 400 encompasses step 416 which includes activating a circular actuator of the suction cup device that decreases a diameter of the cavity of the suction cup device. For the suction cup device 200 of FIGS. 5-8B, step 418 of method 400 can be accompanied by step 416 of method 400, which includes activating an outer flange actuator of the suction cup device that breaks a seal between a rim of the flange and the object surface.

Additional steps of the method can incorporate measuring aspects of the object surface and/or pressures associated with the external environment and the suction cup device and adapting control signals accordingly.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### Computer-Implemented System

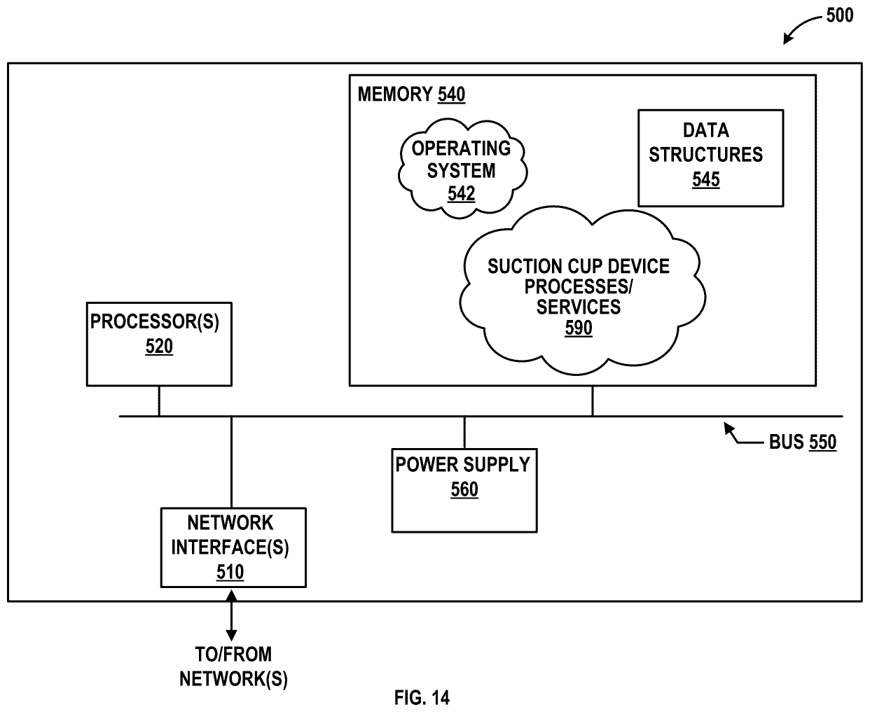

FIG. 14 is a schematic block diagram of an example computing device 500 that may be used with one or more embodiments described herein, e.g., as a component of controller device 104 and/or power supply 106.

Device 500 comprises one or more network interfaces 510 (e.g., wired, wireless, PLC, etc.), at least one processor 520, and a memory 540 interconnected by a system bus 550, as well as a power supply 560 (e.g., battery, plug-in, etc.).

Network interface(s) 510 include the mechanical, electrical, and signaling circuitry for communicating data over the communication links coupled to a communication network. Network interfaces 510 are configured to transmit and/or receive data using a variety of different communication protocols. As illustrated, the box representing network interfaces 510 is shown for simplicity, and it is appreciated that such interfaces may represent different types of network connections such as wireless and wired (physical) connections. Network interfaces 510 are shown separately from power supply 560, however it is appreciated that the interfaces that support PLC protocols may communicate through power supply 560 and/or may be an integral component coupled to power supply 560.

Memory 540 includes a plurality of storage locations that are addressable by processor 520 and network interfaces 510 for storing software programs and data structures associated with the embodiments described herein. In some embodiments, device 500 may have limited memory or no memory (e.g., no memory for storage other than for programs/processes operating on the device and associated caches). Memory 540 can include instructions executable by the processor 520 that, when executed by the processor 520, cause the processor 520 to implement aspects of the controller device 104 and the method 400 outlined herein.

Processor 520 comprises hardware elements or logic adapted to execute the software programs (e.g., instructions) and manipulate data structures 545. An operating system 542, portions of which are typically resident in memory 540 and executed by the processor, functionally organizes device 500 by, inter alia, invoking operations in support of software processes and/or services executing on the device. These software processes and/or services may include suction cup device processes/services 590, which can include aspects of method 400 and/or implementations of various modules described herein. Note that suction cup device processes/services 590 is illustrated in centralized memory 540, alternative embodiments provide for the process to be operated within the network interfaces 510, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the suction cup device processes/services 590 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A suction cup device, comprising:
a body including a sidewall, a flange extending from a distal portion of the sidewall, and a base extending from a proximal portion of the sidewall opposite from the flange;
wherein the base, the sidewall and the flange collectively define a cavity having an open portion associated with the flange, the flange being operable for forming a seal against an object surface that isolates the cavity from an external environment;
wherein the sidewall includes one or more attachment actuators in communication with a controller device, wherein the one or more attachment actuators activate responsive to first control signals from the controller device to attach the flange to the object surface by decreasing a cavity pressure associated with the cavity; and
wherein the sidewall includes one or more detachment actuators in communication with the controller device, wherein the one or more detachment actuators activate responsive to second control signals from the controller device to detach the flange from the object surface.

2. The suction cup device of claim 1, the one or more attachment actuators including a radial actuator embedded within the sidewall that contracts responsive to the first control signals thereby increasing a tension associated with the sidewall and decreasing the cavity pressure associated with the cavity, the radial actuator defining a radial direction of contraction with respect to a central cavity axis associated with the cavity.

3. The suction cup device of claim 1, the one or more attachment actuators including an axial actuator embedded within the sidewall that contracts responsive to the first control signals thereby increasing a tension associated with the sidewall and decreasing the cavity pressure associated with the cavity, the axial actuator defining an axial direction of contraction that is substantially parallel to a direction of elongation of the sidewall.

4. The suction cup device of claim 1, the one or more attachment actuators including an inner flange actuator embedded within the flange and associated with an inner flange surface of the flange, wherein the inner flange actuator contracts responsive to the first control signals and draws the inner flange surface inward towards the base of the body to form a seal between a rim of the flange and the object surface when the flange is in contact with the object surface, the inner flange actuator defining an axial direction of contraction with respect to the inner flange surface.

5. The suction cup device of claim 1, the one or more detachment actuators including a circular actuator embedded within the sidewall that contracts responsive to the second control signals thereby decreasing a diameter associated with the cavity and increasing the cavity pressure associated with the cavity, the circular actuator defining an annular direction of contraction with respect to a central cavity axis associated with the cavity.

6. The suction cup device of claim 1, the one or more detachment actuators including an outer flange actuator embedded within the flange and associated with an outer flange surface of the flange, wherein the outer flange actuator contracts responsive to the second control signals and raises a rim of the flange away from the object surface to break a seal between the rim of the flange and the object surface, the outer flange actuator defining an axial direction of contraction with respect to the outer flange surface.

7. The suction cup device of claim 1, the body including a pliable material that is impermeable to gas and liquid.

8. The suction cup device of claim 1, wherein the one or more detachment actuators are inactive during activation of the one or more attachment actuators and wherein the one or more attachment actuators are inactive during activation of the one or more detachment actuators.

9. The suction cup device of claim 1, wherein the one or more attachment actuators deactivate following secure attachment of the flange to the object surface.

10. The suction cup device of claim 1, wherein the one or more attachment actuators include a spring formed from an electro-active material that is electrically coupled to a power source and is operable to transition from a relaxed state to a contracted state having a reduced length when a first control signal passes through the spring.

11. The suction cup device of claim 1, wherein the one or more detachment actuators include a spring formed from an electro-active material that is electrically coupled to a power source and is operable to transition from a relaxed state to a contracted state having a reduced length when a second control signal passes through the spring.

12. A method, comprising:
contacting an object surface with a flange of a suction cup device, the flange isolating a cavity of the suction cup device from an external environment;
activating an attachment actuator of the suction cup device to decrease a cavity pressure of the cavity relative to the external environment and attach the suction cup device to the object surface; and
deactivating the attachment actuator to initiate a passive attachment mode of the suction cup device.

13. The method of claim 12, the attachment actuator including a spring formed from an electro-active material that is electrically coupled to a power source and is operable to transition from a relaxed state to a contracted state having a reduced length when a voltage is applied to the spring, the method further comprising:
activating the attachment actuator by a first control signal that applies the voltage to the attachment actuator, causing the attachment actuator to transition from the relaxed state to the contracted state having the reduced length.

14. The method of claim 12, the attachment actuator including a radial actuator and the method further comprising:
activating the radial actuator of the suction cup device that increases a tension associated with a sidewall of the suction cup device;
the radial actuator defining a radial direction of contraction with respect to a central cavity axis associated with the cavity.

15. The method of claim 12, the attachment actuator including an inner flange actuator and the method further comprising:
activating the inner flange actuator of the suction cup device that draws an inner flange surface of the flange upward to create a suction force that forms a seal between a rim of the flange and the object surface;
the inner flange actuator defining an axial direction of contraction with respect to the inner flange surface.

16. The method of claim 12, the attachment actuator including an axial actuator and the method further comprising:
activating the axial actuator of the suction cup device that decreases a height of the cavity and draws the flange and object surface upward;
the axial actuator defining an axial direction of contraction that is substantially parallel to a direction of elongation of a sidewall of the suction cup device.

17. The method of claim 12, further comprising:
activating a detachment actuator of the suction cup device to increase the cavity pressure of the cavity relative to the external environment and detach the suction cup device from the object surface.

18. The method of claim 17, the detachment actuator including a spring formed from an electro-active material that is electrically coupled to a power source and is operable to transition from a relaxed state to a contracted state having a reduced length when a voltage is applied to the spring, the method further comprising:
activating the detachment actuator by a second control signal that applies the voltage to the detachment actuator, causing the detachment actuator to transition from the relaxed state to the contracted state having the reduced length.

19. The method of claim 17, the detachment actuator including a circular actuator and the method further comprising:
activating the circular actuator of the suction cup device that decreases a diameter of the cavity of the suction cup device;
the circular actuator defining an annular direction of contraction with respect to a central cavity axis associated with the cavity.

20. The method of claim 17, the detachment actuator including an outer flange actuator and the method further comprising:
activating the outer flange actuator of the suction cup device that breaks a seal between a rim of the flange and the object surface;
the outer flange actuator defining an axial direction of contraction with respect to an outer flange surface of the suction cup device.
